(19) United States
(12) Patent Application Publication
(10) Pub. No.: US 2015/0019350 A1
(43) Pub. Date: Jan. 15, 2015

(54) LOCALLY AND AUTOMATICALLY ARTICULATED CONTENT REQUESTER TECHNOLOGY

(71) Applicant: AD-VANTAGE NETWORKS, INC., Glendale, CA (US)

(72) Inventors: David S. Grant, Mission Viejo, CA (US); Sanjeev Kuwadekar, Northridge, CA (US)

(21) Appl. No.: 14/200,555

(22) Filed: Mar. 7, 2014

Related U.S. Application Data
(60) Provisional application No. 61/799,624, filed on Mar. 15, 2013.

(51) Int. Cl. G06Q 30/02

(52) U.S. Cl. CPC G06Q 30/0275
USPC 705/14.71

(57) ABSTRACT

Certain embodiments of locally and automatically articulated content requester technology (LAACRT) may enable bandwidth/internet access providers and premise operators to provide improved opportunities for advertising and content to be delivered to an end user. Advertising content may be identified by the system and, optionally, blocked and/or replaced prior to being transmitted to a user terminal. Bids may be solicited from advertising publishers for replacement ads to be displayed in place of the blocked advertising content.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference under 37 CFR 1.57.

### BACKGROUND OF THE INVENTION

1. Field of the Invention

Embodiments disclosed herein relate to systems and methods controlling the transmission and display of digital content to users.

2. Description of the Related Art

The Internet has become an essential tool for large numbers of people. The Internet is used to perform searches, run applications, review content, communicate with others, house emails and files, etc.

With respect to the Internet, conventionally it has been difficult for users and access providers to adequately manage programming and content. In particular, because the content is now embedded in web pages it makes it difficult for users and access providers to manage the content they see or execute on their devices. For example, the Internet generally does not adequately enable the restriction of certain product placement, such as tobacco advertisements in children's programming, or the monitoring of produced or real-time streaming content.

Further, from the perspective of consumers, the Internet suffers from other deficiencies. Publishers can add tags into their pages that display ads to the highest bidder or install scripts that access potentially private information. Embedded content is also the vehicle typically used to deliver viruses to users such as the Trojan Virus and RootKit virus which can be used to damage a user's finances, breach the user's privacy, and damage the user's connected device.

### SUMMARY OF THE INVENTION

The present disclosure is related to methods and systems for allowing content publishers, media broadcasters and network access providers better ways to maximize the relevancy and value of the content and advertisements provided to users.

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one aspect, a method of selecting and displaying digital content at a user terminal, the method comprises: receiving, at the user terminal, data for a webpage from a remote system, wherein the webpage is to be displayed on the user terminal; causing, at least in part, an automatic identification of a first advertisement in the webpage data, wherein the first advertisement is configured to be displayed in a first area of the webpage; replacing said first advertisement with a placeholder; collecting information comprising: (a) information related to the webpage; (b) information related to the user; or (c) both (a) and (b); soliciting bids for advertising content to be displayed in the first area corresponding to the placeholder, wherein soliciting the bids comprises providing at least a portion of the collected information; receiving bids for advertising content to be displayed in the first area; selecting a winning bid from among the received bids; and causing, at least in part, advertising content associated with the winning bid to be displayed on the user terminal in the first area corresponding to the placeholder.

In some embodiments, the first advertisement comprises a link to advertisement content. In some embodiments, said placeholder comprises a container or ad tag. In some embodiments, information related to the user comprises demographic information. In some embodiments, soliciting bids comprises soliciting bids from multiple advertising exchanges.

According to another aspect, a method of selecting and displaying digital content comprises: receiving, at a network node, data for a first document from a remote system, wherein the first document is to be displayed on a user terminal of a user; causing, at least in part, an automatic identification of a first advertisement in the first document data; soliciting bids for replacement content to be displayed on the user terminal in place of the first document; receiving bids for replacement content; selecting a winning bid from among the received bids; and causing, at least in part, replacement content associated with the winning bid to be displayed on the user terminal in place of the first document.

In some embodiments, the network node is the user terminal. In some embodiments, the first document comprises a web page. In some embodiments, the first advertisement comprises a link to advertisement content. In some embodiments, soliciting bids for replacement content comprises: providing information related to the user, providing information related to the first document, or both. In some embodiments, soliciting bids comprises soliciting bids from multiple advertising exchanges substantially simultaneously. In some embodiments, selecting a winning bid comprises comparing the received bids and identifying a bid with the highest offered price. In some embodiments, storing a record of the winning bid. In some embodiments, the method further comprises causing, at least in part, said record to be provided to one or more of bidders of the received bids.

In accordance with another aspect, a system, comprising: a processor; tangible, non-transitory media configured to store a program that when executed by the processor is configured to perform operations, comprising: receiving, at a network node, data for a first document from a remote system, wherein the first document is to be displayed on a user terminal of a user; causing, at least in part, an automatic identification of a first advertisement in the first document data; soliciting bids for replacement content to be displayed on the user terminal in place of the first document; receiving bids for replacement content; selecting a winning bid from among the received bids; and causing, at least in part, replacement content associated with the winning bid to be displayed on the user terminal in place of the first document.

In some embodiments, the network node is the user terminal. In some embodiments, the first document comprises a web page. In some embodiments, the first advertisement comprises a link to advertisement content. In some embodiments, soliciting bids for replacement content comprises: providing information related to the user, providing information related to the first document, or both. In some embodiments, soliciting bids comprises soliciting bids from multiple advertising exchanges substantially simultaneously. In some embodiments, selecting a winning bid comprises comparing the received bids and identifying a bid with the highest offered price. In some embodiments, the operations further comprise storing a record of the winning bid. In some embodiments, the operations further comprise causing, at least in part, said record to be provided to one or more of bidders of the received bids.

### BRIEF DESCRIPTION OF THE DRAWINGS

The disclosed aspects will hereinafter be described in conjunction with the appended drawings, provided to illustrate and not to limit the disclosed aspects, wherein like designations denote the elements.

FIG. 1 illustrates an example architecture for a locally and automatically articulated content requester technology (LAACRT) system.

FIG. 2 illustrates an example process for soliciting bids and displaying winning content.

FIG. 3 illustrates an example user interface.

FIG. 4 illustrates an example process for verifying a publisher's content.

### DETAILED DESCRIPTION OF THE PREFERRED EMBODIMENT

Certain embodiments of the locally and automatically articulated content requester technology (LAACRT) described herein may enable content publishers, media broadcasters and network access providers to enhance the relevancy and value of the content and advertisement associated with the products and services they provide. Improved relevancy and value may enable service providers to gain higher revenues for providing improved or more convenient services for their members and consumers. Optionally, these revenues may be employed to lower or eliminate consumer access costs by reducing or offsetting the access provider's infrastructure costs to enable Internet access. In addition or instead, such revenues may be used to improve consumers' access experience by enhancing access to more quality content and restricting distracting or irrelevant content such as popups, or distracting advertisements, that are typically unwanted by consumers.

Over many years consumer access to free or low cost programming and content has been fueled by advertisements. This is true for radio, television, and cable. However, the rapid growth of the internet and overwhelming availability of digital media outlets have fundamentally transformed target marketing and the delivery of online display or streaming advertisements. The mathematical product of the abundance of possible internet content destinations, such as URLs, and the random probability that a consumer might visit any given site at a given point, makes the odds against a user viewing a given advertisement, at times astronomical.

To address this problem, data aggregators and other intermediaries have inadequately attempted to create statistical or predictive targeting models for advertisers based on site content, IP address and other derived data, to help advertisers ensure their ads are provided to the desired target users. Advertisers and publishers have come to rely on these often expensive intermediary services to help them mitigate the volume of possibilities to best reach their potential customers. To reduce missed opportunities which may result from the inadequacy of the targeting models, advertisers frequently bid or buy more opportunities than needed to improve the odds of reaching their desired target audience or to prevent their competition from reaching such target audience.

This conventional approach has resulted in escalating advertising and marketing costs which are often passed on to consumers. It has also fostered more aggressive advertising techniques that seek to identify users and control the user experience with forced ads, such as popups, pop-unders, modal ads, interstitial ads or other techniques, which may be highly annoying to consumers, to ensure that consumers receive and view the targeted advertisement.

The efforts to control the target data, the advertising, and the delivery methods have resulted in the consolidation of a few monolithic advertising intermediaries. These companies seek to control the holistic view of behavioral data across multiple destinations, even when such control and consolidation does not serve consumers, market economics, or innovation well.

In fact, several of these advertising intermediaries now face investigation for antitrust violations, monopolistic practice, and even admit to bypassing consumer safeguards to capture consumer or competitor data.

For example, consider that in roughly a decade a small search engine company with limited offerings other than the aggregation of data from other internet site (Google) grew to be one of the most powerful companies in the world with most of their revenues coming from advertising and the use of target data they quietly collected through their advertising services.

In recent years advertising intermediaries have introduced new “free” offerings that amplify their ability to capture end-user data and push more targeted advertisements, exacerbating the market economics while also introducing technical challenges. These ever larger advertising intermediaries are now drawing the attention of governmental authorities and consumer advocate organizations related to overreaching practices and are now under investigation by federal authorities for hacking, security breaches, privacy issues, and unfair trade practices.

Meanwhile, network operators and access providers who subsidize the networks that enable these advertisements and data targeting services conventionally do not share in these revenues. In order to maintain the historically stable media transmission ecosystem and continue to offer consumers Internet access services, more and more network operators and access providers are being forced to pass some or all of their access service costs onto consumers.

In this destabilizing ecosystem, advertisers now depend on a few large intermediaries to survive and compete because these intermediaries control the advertising and the target data, leaving advertisers with few options.

However, the rapid consolidation into few large companies have created some inherent disadvantages, some or all of which embodiments described herein may resolve. For example, in order to process the very large number of advertising possibilities discussed earlier, while remaining responsive from a user perspective, these large intermediaries require a considerable amount of processing power to aggregate data, processes this data, and deliver a result. Because their models are built on aggregation and disintermediation, they have introduced inherent latencies in serving advertisements and/or in serving documents, such as webpages. Further, because these intermediaries reside between the consumers, the publishers, and the advertisers, they limit direct, real-time communication and are limited by industry standard security techniques. Nonetheless some of these large intermediaries have attempted to cross these boundaries, lobby to change them, and have admitted to hacking or circumventing security paradigms to gain access to more consumer data. Several intermediaries have also introduced new technologies to completely bypass the security safeguards in order to reduce latencies, improve direct, real-time communication, and gain additional consumer data.

Other inadequate techniques have been developed in an attempt to address certain of the disadvantages, however in order to provide marginally competitive services publishers and advertisers rely on ad exchanges, demand side platforms and remnant advertising vendors, which often service less trafficked destinations sites or include less desirable ads. To mitigate their “low quality of offering” status these intermediaries attempt to offer real-time bidding or trade between ad networks in somewhat of a round-robin or sequentially diminishing hunt for the best advertisement to offer. These services introduce several disadvantages for publishers and access providers. Latency is disadvantageously increased because the advertising opportunity may have to be offered several times though multiple networks in an attempt to achieve the highest price (e.g., for the highest bid). Data integrity may be adversely impacted, because data passed between intermediaries can degrade rapidly, where the degradation may increase as the number of intermediaries through which the data passes increases. Ad entropy may be increased as well because the quality and the value of the ads can often spiral downward based on performance, data, and timing.

Certain embodiments of the LAACRT methods and systems disclosed herein may solve one or more drawbacks inherent with intermediaries by enabling a localized agent within the accepted security paradigm that automatically promotes advertising competition for a relevant advertising opportunity. This can help re-establish safety, market balance, and create a level playing field for advertisers, consumers, publishers, and access providers. This may enhance the user experience, reduce latency, reduce the costs and need for wasted advertisements, reduce the aggressive, and often annoying, techniques created by intermediaries to capture consumer attention, and mitigate the desire to breach security paradigms to gain more value from a closed system.

Locally and automatically articulated content requester technology (LAACRT) can be implemented as stand-alone software, add-on software, programming script or firmware that may run on one or a plurality of computer system (including one or more processing devices) connected to a network and/or via the use of dedicated hardware.

By way of illustration, an example embodiment may include script, such as HTML script, which may be in a form similar to an ad tag, an object code container, or browser add-on that was installed on behalf of the user or by a service selected by the user. Such a script or container may be used to overlay or replace advertisements or advertising placeholders, to thereby maintain or substantially maintain the existing site or content format and user experience, and/or they can be placed in un-used or open spaces within a page or site so as not to materially affect the publisher content. This HTML script may be self-aware, page-aware, and/or aware of other similarly placed scripts or containers within the destination page. For example, if the script is in the network (e.g., being executed by a network device), it may know or be able to determine other IP addresses, if the script is in the browser (e.g., being executed by the browser), it may detect one or more of the version, IP address, URL, etc.; if the script is in the page, it may know or be able to determine the page, location on the page (e.g., coordinates), URL, meta data, and other such data in the page; if the script is in a set top box or TV, it may know or be able to determine the channel, time, program, rating, etc. Unlike conventional intermediary ad tags and programs that are activated by virtue of their midway position between the websites and the user terminal, and therefore are also limited by industry standard security paradigms, the LAACRT script may be safely authorized within industry standard security paradigms to enable more accurate targeting information to a plurality of possible advertisers, ad networks, or ad exchanges from the user endpoint. For example, LAACRT, in certain embodiments, is configured as a distributed, localized solution that executes from within the user's computer, the user's browser, the user's dedicated equipment, and/or a web page. In some embodiments, a user can provide, and the LAACRT system can receive, consent from the user for the system to run the HTML script and replace or overlay advertisements and/or to perform other functions discussed herein. Since the LAACRT script can run from within the user's computer, browser, etc., it can avoid many of the limitations imposed upon intermediaries by the standard security paradigms. This is a significantly different structure and enables a plurality of advertisers to openly and fairly compete for this opportunity.

LAACRT may also mitigate the need for considerable processing power of conventional techniques, and may reduce the latency often visible to users needed to maintain response. LAACRT, in certain embodiments, is configured as a distributed, localized solution that executes from within the user's computer (or other user terminal), the user's browser, the user's dedicated equipment (such as, but not limited to, a Wi-Fi router, set-top box, cable box, TV or DVR device), and/or a web page. For example, optionally a single LAACRT container, LAACRT place holder, and/or LAACRT ad tag may optionally be configured to collect non-identifiable page information, user controlled demographic information, and/or other similar or non-similar information, and broadcast some or all of the collected information nearly simultaneously or in parallel to a pre-determined or a dynamically selected plurality of advertisers, ad networks and/or ad exchanges for their bid. Advertisers, ad networks, and/or ad exchanges receiving the more accurate, relevant and un-degraded information from the source user may selectively choose to respond with their bid for the right/opportunity to advertise to the user.

The LAACRT bid request may optionally also be configured to categorize the advertising opportunity with respect to various criteria, such as one or more of site location, page content, site rating, site type, advertising position in the page or stream. The LAACRT bid request may also designate acceptable responses such as media type, MIME type, advertising rating, minimum price, latency expectation or requirements, and/or other attributes, so as to improve the quality of advertising with respect to the user and the publisher. The bid request may specify an allowed time within a response will be considered, wherein after such time the bid may optionally be rejected or otherwise not accepted.

LAACRT may optionally be configured to receive and aggregate bids from responding advertisers to select from a number of advertisements an appropriate advertisement (e.g., the most appropriate advertisement) based at least in part on such bid categorization and requirements. For example, bidders that did not respond to the LAACRT advertising request in the allowed time might be ignored simply to reduce latency. To optimize or reduce latency, LAACRT may optionally be configured to accept bids and a reference to the advertising to reduce or minimize network delay and/or reduce or minimize back and forth communication.

After a winning bid is selected by LAACRT system and, on behalf of the user, the LAACRT system may be configured to cause the advertisement to be displayed directly. For example, if the advertisement has been included with the bid, then the LAACRT system can cause the advertisement to be displayed upon selection of the winning bid. Alternatively, upon selection of the winning bid, the LAACRT system may request the advertisement in a subsequent communication, or enable the advertiser's ad tag which is inherently limited by the security paradigms and does not include the same user authority granted to the LAACRT system by the user. As described elsewhere herein, in some embodiments the LAACRT system may include a script executed on the user side (e.g., in the user's terminal, user's browser, etc.), and accordingly can be authorized with access unavailable to advertisers. The LAACRT system is configured to optionally perform some or all of such functions asynchronously and in background via the distributed framework enabled by LAACRT, to thereby significantly reduce or eliminate user latency.

Certain embodiments also communicate information regarding the winning bid such as, by way of example, response times, amount of winning bid, reason for winning bid, and/or other information, back to some or all responders to the bid request so that they may continue to improve their service and enhance the value of such services to the user and publishers.

In some embodiments, the LAACRT system is configured to track information regarding response times, content delivery, and/or other performance measurements of the bidders. In some embodiments, bidders with slower response times, or who introduce latency in the delivery of content (as determined from the tracked information), are optionally penalized by the LAACRT system in future biddings. Conversely, bidders with fast response times and/or who do not introduce undue latency in the delivery of content (as determined from the tracked information), may be rewarded with preferential treatment in future bids. For example, a fast bidder might get called first or more often (e.g., may be provided with offers to bid on opportunities relatively earlier than slower bidders, or relatively more often, and/or may be offer better/more preferred opportunities to bid on as compared to slower bidders). Slow or unreliable bidders might get cut off (e.g., the system may inhibit the broadcast of offers to bid on opportunities to such unreliable bidders, the system may reject bids from such unreliable bidders) or relegated to lesser opportunities so as not to slow down the process, at least until their metrics demonstrate improvement (e.g., for a specified period of time) in which case they may manually or automatically be provided with enhanced treatment (of which there may be multiple levels) based at least in part on their performance and reliability. The same can be true with respect to cost and quality.

Optionally, the LAACRT system is configured to pass additional information not available to intermediately placed technologies within the security paradigm that increases the value of the LAACRT technology and advertising integrity to eco-system participants to improve overall experience. For example, the LAACRT system may be configured to provide information indicating or demonstrating the advertisement was visible. By way of further example, the LAACRT system may provide some or all of the following information: the time the advertisement was in viewable space, whether the page was scrolling, if mouse movement was detected, and/or other information received or detected when the advertisement was being displayed (e.g., which may indicate that the advertisement was displayed, viewed and/or interacted with by the user).

The LAACRT system may be configured to also refresh content, activate new content, cycle through subsequent bids in selective order (e.g., after displaying the winning bid's advertisement for a period of time, the second highest bidder's advertisement may be displayed), or request a new advertisement based at least in part on page characteristics, a specified display duration, a random display duration, user activity metrics, perceived value of a dormant advertisement, other page activities, and/or other LAACRT system objects. An ad may be designated as exclusive (e.g., where the ad is not switched or rotated out for another ad) or as having an X display time, where X is a configurable time that the ad remains without rotation. If a user scrolls so the ad is out of view, but the ad comes back into view, X might be for a viewable time or may be for total time. In another aspect, location on the page (e.g., top, top right, mid, etc.) may be incorporated into the analysis.

Ads may be considered dormant in the sense that they can become asymptotically less valuable after a few seconds (e.g., if the user was going to click or in interested they would have clicked or kept the ad in view). If there is no client, dwell or gesture indicating interest, the ad may be considered dormant. Similarly, if the ad goes out of view for a period of time and comes back into view, it may trigger a change event. A user may also park a page (i.e., no activity for a time), and the ad may be a changed or rotated once activity on the page resumes.

The LAACRT system may also be configured to communicate with other LAACRT system placeholders or with advertisements inserted by the LAACRT system, to enhance value and user experience. For example, the LAACRT system may be configured to synchronize the display of selected page advertisements, such as a banner advertisement and a streaming media advertisement, or a banner advertisement and a coupon advertisement matching the service or product in the banner advertisement, to enhance the value to the consumer and the opportunity to the advertiser.

The LAACRT system may be configured to use inter-page or inter-container communications between the LAACRT system scripts to reduce page clutter, reduce page annoyance to the user, or enhance the number of companion ads within a site as a user traverses a page, listens or watches a media stream, and/or scrolls around a page or navigates to other pages or sites.

Currently, conventional intermediaries may lack the ability to offer features described herein because they are limited by security considerations and systems. As noted above, in some embodiments LAACRT may be implemented as a distributed, localized solution that runs from within the user's computer, the user's browser, the user's dedicated equipment (such as, but not limited to, a Wi-Fi router, set-top box, cable box, TV or DVR device), or a web page. By virtue of its distributed implementation, in some embodiments the LAACRT system is privy to certain user information not otherwise available to intermediaries. This information can be used to provide increased value for advertisers, increased revenue for network access operators, and increased relevancy of content displayed to users. Additionally, the distributed nature of the LAACRT system may reduce latency as compared with the latency caused by intermediaries.

In various embodiments, the LAACRT system can solicit bids substantially in parallel from a variety of ad exchanges. With this approach, two or more real-time bidding engines can compete with one another for price, speed of providing the advertisement to be displayed, and content. In some embodiments, a response time limit may be imposed to avoid or reduce latency. For example, the LAACRT system may specify and communicate to bidders/bidding engines that they need to provide a response to a request for bid within 56 milliseconds (or other desired time period), after which further bids will be ignored or otherwise treated adversely. As noted above, in some embodiments the LAACRT system can provide information to the advertising providers that submitted losing bids.

Once a winning bid is determined by the LAACRT system (e.g., based on bid amount and/or other criteria discussed herein), the LAACRT system can provide the advertisement for display on the user terminal, for example by inserting the advertisement in place of a LAACRT placeholder tag or by replacing an advertisement. The manner in which the advertisement is displayed can be varied according to rules imposed by the LAACRT system. For example, the selected advertisement can be displayed for a pre-defined period of time, for example 5 seconds or other time period. In some embodiments, the selected advertisement may only be provided for display or run when the area in which the advertisement is to be positioned falls within the visible portion of the user's browser. For example, a plurality of advertisements may be positioned on a given web page. As a user scrolls vertically and/or horizontally along the web page, one or more of the advertisements may not be visible to the user. Under current approaches, un-viewable advertisements are still included and executed in the page. In some circumstances, these advertisements may include video, Flash, other executable media, etc. The running of such advertisements even when not visible may increase network bandwidth usage and deleteriously affect the user's browsing experience, without benefiting the advertiser. Accordingly, it can be advantageous to selectively provide for display and/or execute advertisements only when such advertisements would be viewable by a user, for example when a browser window is positioned with at least a portion of the ad in the viewable area.

In some embodiments, advertisements may be rotated for display within a given page area so that the advertisements are displayed sequentially in that area. For example, after a first advertisement is displayed for a pre-defined period of time, such as 5 seconds, the first advertisement may be replaced by a second advertisement, which may similarly be displayed for a pre-defined period of time (which may be the same or different than that of the time period of another advertisement). In some embodiments, the rotation of ads can be ongoing indefinitely. In some embodiments, the rotation of ads can be selectively applied. For example, ads may only be rotated when the displayed advertisement is viewable by a user (e.g., the advertising space falls within a browser window).

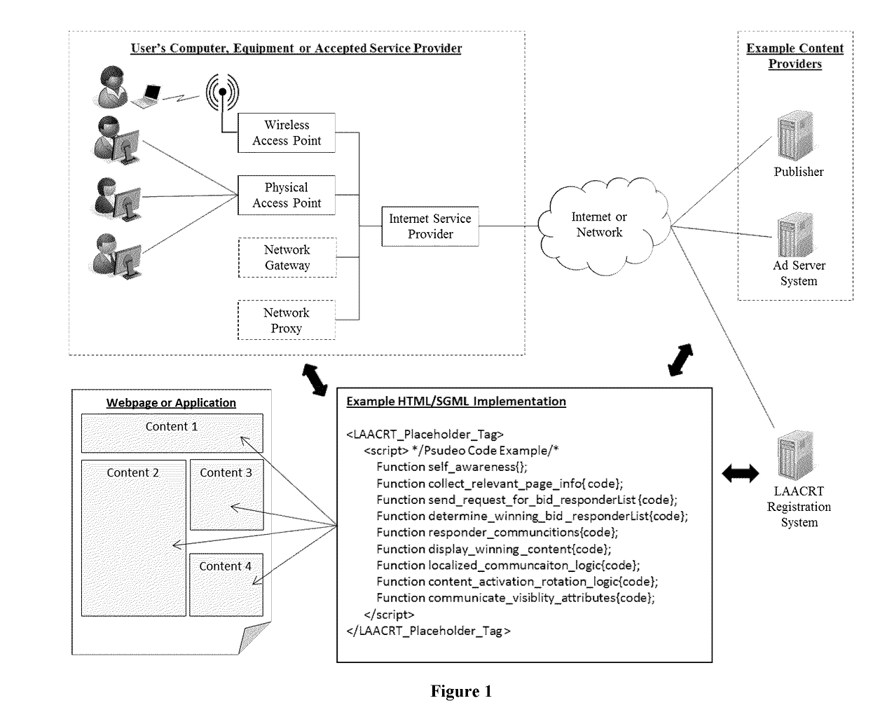

FIG. 1 illustrates an example HTML script implementation using pseudo-code and an example system architecture that may be used to demonstrate certain features of the LAACRT technology. Other components and configurations may be used as well.

In the illustrative example of FIG. 1, a user browses a document, such as a webpage, on a connected device. The document (e.g., webpage) contains a plurality of items content from different sources. Some or all of the content may be dynamically created and determined only after reaching the user's connected device. For example, the connected device may be a terminal including a display and user input device. By way of example and not limitation, a terminal may be in the form a general purpose computer, a laptop computer, a tablet computer, a phone, a networked television, a gaming device, etc. In this example, the content publisher may surround some or all the content it publishes with tags, such as HTML tags, that identify the content source, the type of content that is being transmitted, the content rating, and/or other attributes that can be used to evaluate the safety and value of this content to the access provider and end user. Thus, for example, the tags may be monitored by the script, and based at least in part on an examination of the tags, a determination may be made by the script as to which content is to be displayed and which content is to be blocked or substituted with other content.

For illustrative purposes, in the example of FIG. 1 Content 1 and Content 2 are permitted by the system executing the script, and so may be displayed on the page; however, the script determines that Content 3 fails to meet the requirements (e.g., specified by an access provider, premise operator, and/or user) and is blocked or substituted by the system, optionally without affecting other content or page layout. In this example, Content 1 may be a news article of known origin as determined by inspection of Content 1 and/or associated metadata, such as associated tags (e.g., HTML tags). The tags may identify the publisher as CNN or Wall Street Journal, for example. The content type may be labeled, via a tag or otherwise, as news. The fee (e.g., charged by the access provider or premise operator or a CPM (Cost per mille/thousand), CPC (Cost per click), or other fee (e.g., revenue) that the publisher or advertiser is willing to pay) may be specified via a tag or otherwise as $0.00, and the event tag may have a null value. In various embodiments, one or more of the tags and/or tag values may be omitted. For example, as described in more detail below, in some embodiments the fee, content type, height, and/or other attributes and associated tags may be omitted.

In one embodiment, identified advertisement content may be stripped from the webpage or application and replaced with by the LAACRT system with a placeholder tag. For example, Content 2 may be an advertisement from a well-known ad serving provider, such as DoubleClick or ValueClick. The content type may be advertisement, the fee (as described above) may be $0.001 and the event may include additional actions if the user clicks on the advertisement. In this example, Content 3 may also be an advertisement but did not include the needed tags for identification purposes and/or failed to meet permission criteria, as indicated by a rating tag, such as a content rating for a given site. The LAACRT script may examine Content 3 and/or associated tags and determine that if Content 3 failed a source identification determination and/or permission criteria.

In some embodiments, ad toll technology may be employed by the system. In an example embodiment, one or more toll booth locations or sites register with the registry and a given toll booth location records the passage of an ad based in whole or in part on delivery to a user. Further details of ad toll technology can be found in U.S. Provisional Application Nos. 61/648,450 and 61/793,832, which are hereby incorporated by reference in their entirety.

Optionally, an advertisement has to be delivered to a user connected device in order for the network provider and/or publisher to be provided payment with respect to the advertisement. In an optional embodiment, if an advertisement traverses networks of multiple network operators, then revenues or payments with respect to the advertisement may be split among the multiple network operators and, in certain circumstances, the user to whom the advertisement is delivered. For example, if an ad traverses the networks of three network operators in order to reach the end user terminal, and each of the network operators (and optionally the user) is registered with the system, then the revenue may be split based at least in part on one or more network parameters (how many network segments (e.g., network operator A might traverse the advertisement from point A to B via a national network link, network operator B might traverse the advertisement from point B to point C via a local ISP link, and network operator C might traverse the advertisement from Point C to the user terminal via their WiFi network), how far or number of hops (e.g., the number of routers or routes traversed from the sender to the receiver, in which optionally a given router/route may have an associate detailed cost)) and/or what percentage or revenue share is indicated by the ad tag itself, registry rules, and/or otherwise. The network parameters may be equally or unequally weighted in determining how the revenues/fees are to be split.

Access requirements may optionally be configured and managed in an access profile record via a web application or client application accessed by a customer or account manager. This profile may include rules or access thresholds based, at least in part, on physical location, bandwidth characteristics, virtual location, cost metrics, or location type such as a hotel property or small coffee shop business and/or other criteria. Rules may also be configured based on account, physical or logical network, virtual network characteristics and/or the type of connection such as, but not limited to, free, paid limited access or paid full access. These rules may also be automatically or dynamically derived based on real-time factors or conditions such as active URL, page content, time of day, day of week, use, current events and/or other factors that might affect the triggering or targeting of dynamic content.

A non-limiting example illustrating an example process flow will now be described. A user may access a network access device, such as a free public WiFi network hotspot (that is privately owned) with terms and conditions covering network usage and advertising (e.g., where the user clicks on an accept control or otherwise indicates acceptance of the terms and conditions). When the user accesses Internet content, such as a web page, via the private network, the rules defined by the private network operator for the private network may cause the system to selectively enable (or block) specific advertisements to pass through the private network based on specific conditions, such as, by way of example, appropriate rating, publisher URL, and/or pre-established agreements such as an access fee or threshold revenue amount.

By way of further example, an advertiser may utilize an HTML tag and URL reference to return their advertisement. The ad tag may be in the form of an HTML place holder, and may be inserted by the publisher when a page (e.g., an HTML Web page) is served. Optionally, when the page reaches the user terminal, an ad tag script is executed by the browser, and passes back information to the ad provider system, such as cookie data, IP address and/or the current URL, enabling the ad provider to dynamically select a relevant or best ad for the user. The ad image may not actually be in the page. Instead, a reference to a program that will find the image may be included in the tag. The LAACRT system or script, applying the private network operator rules, may parse this tag and/or programmatically reference the tag's characteristics and determine inhibit the showing of this advertisement if the content rating is determined (e.g., by inspecting a content rating tag) to be inappropriate for the viewer and/or the location (e.g., the website the viewer is viewing or the physical facility housing the WiFi hotspot). For example, a coffee shop with a hotspot may not want obscene or offensive material to be displayed on user terminals, within the coffee shop, accessing the hotspot. The rules, as applied by the LAACRT system or script, may also evaluate a revenue attribute for this particular advertisement (e.g., by inspecting an appropriate tag) by comparing the revenue attribute to an acceptance threshold value as pre-specified by the network operator or as otherwise specified, and choose not to prevent the advertisement from passing through the network if the revenue attribute is determined to be below the acceptance threshold. As noted above, in some embodiments the LAACRT system can block some or all identified advertising content and replace it with a the LAACRT Placeholder tag.

If, in this example, the LAACRT system or script determines that the rules indicate the advertisement is to be allowed to pass, the system may enable the advertisement to be delivered to the user's terminal, the delivery of the advertisement may be recorded by the system, optionally in association with some or all of the associated tag information, such as tag information identifying the publisher, the advertisement, the revenue offered for the ad, the network or networks the advertisement passes through, and/or other such information. Such stored tag information may be utilized by the LAACRT system or otherwise to determine who revenue is to be collected from. For example, the LAACRT system may use the tag information to collect revenue from (e.g., charged to) the registered publisher of the ad.

Unlike conventional URL or ad blockers applications, the LAACRT system or script may instead or in addition evaluate the source and attributes of a given content element to determine whether the defined rules of the access provider and/or user indicate that this content is permitted to be routed over their equipment and/or provided to the user terminal (e.g., laptop, tablet, desktop, cell phone, networked television, etc.), or whether the rules indicate that the content is not to be routed over their equipment and/or provided to the user terminal.

In a scenario in which the advertisement had to pass through multiple private networks (previously registered in the network), such as passing first through an Internet service provider (ISP), and then through an operator's private hotel network, and finally to a WiFi network operated at a concession shop at the hotel, then a portion of the revenue may be shared between each of these operators equally or computed based on the network length, cost, number of routers or other similar characteristics of the networks. Optionally, not all network private operators whose networks the advertisement traverses are entitled to such revenue. Optionally, where a user's terminal (e.g., a computer) may also contribute to this delivery (e.g., by receiving and display the advertisement), and the rules may also be applied with respect to the user and/or user terminal, the user may share in revenues enabling the distribution of content. The registry may also store user-specific data and enable the user to also configure rules governing the permission or denial of content passing into their computer in the same or similar manner as the network operators.

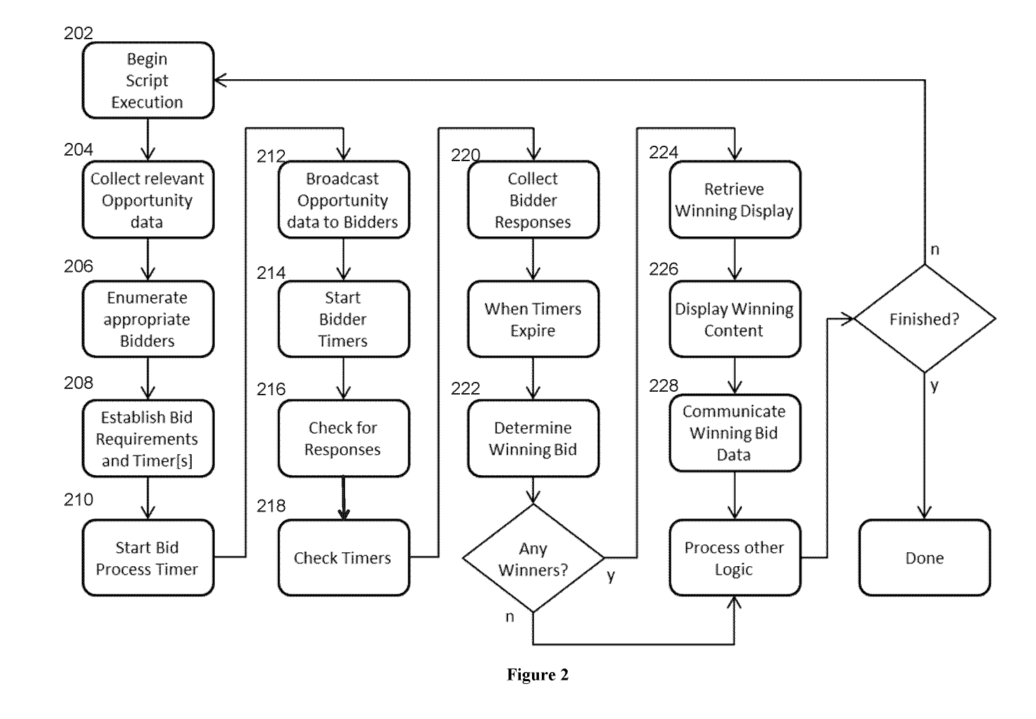

As noted above, in scenarios in which content is restricted from passing by the LAACRT system, the system may replace the content with a the LAACRT system placeholder tag. The system may then solicit bids to identify and display replacement advertising content in place of the LAACRT placeholder tag. A non-limiting example illustrating an example process flow for soliciting bids and displaying winning content will now be described with respect to FIG. 2. At state 202, the script execution may begin. At state 204, relevant advertisement opportunity data is collected. For example, the LAACRT placeholder tags can be identified and information regarding the container, the page, the user, etc. can be collected or identified. At state 206, the LAACRT system may enumerate appropriate bidders. In some embodiments, bidders may be selected from an active exchange market. In some embodiments, bidders may be enrolled into a proprietary bid exchange platform. At state 208, the LAACRT system may establish bid requirements and timers with respect to the advertisement opportunities. For example, the LAACRT system may require any bids to be received within a given period of time (e.g., within 50 milliseconds) in order to be substantially evaluated or accepted, and/or may impose other requirements on the bids.

At state 210, a bid process timer is initiated by the system (e.g., a bid process might be limited to 200 ms). At state 212, some or all of the opportunity data is broadcast to bidders (e.g., to bidder systems). At state 214, bidder timers are initiated by the LAACRT system (e.g., all bids might be required to be submitted within 50 ms, such that the entire processing and selection may take less than 200 ms). At state 216, the system checks for responses received from bidders, at state 218 checks timers (e.g., to determine if the bids have been received within the specified time period), and at state 220 collects (and optionally time stamps) the received bidder responses. When timers have expired, the LAACRT system at state 222 determines the winning bid based on bid amounts and/or other criteria discussed herein (and the system may reject any bids received after timer expiration). If there are no winning bidders, the LAACRT system may, in accordance with bidding process procedures, and optionally begin the process again. In some embodiments, if there are no winning bidders, the LAACRT system may display a default advertisement. If the system selects a winning bidder, at state 224 the LAACRT system retrieves the ad content associated with the winning bid (e.g., an image, video, animation script, etc.). As noted above, in some embodiments the ad content is included along with the submitted bid or a link (e.g., a URL or other locator, may be submitted with the bid). At state 226, the LAACRT system then provides the winning content for display on the user's connected device in place of the LAACRT placeholder tag. At state 228, some or all of the winning bid data can then be communicated to the winning bidder and, optionally, to one or more of the losing bidders.

Additionally, an access provider or user may permit content to be routed and/or displayed for value received. For example, the access provider may allow advertising content to pass over their network for a fee to help offset the cost of the equipment necessary to enable the user's connection. As another example, there may be users who do not particularly like advertisements but who are willing to selectively accept the display of such advertisements on the user's terminal in exchange for free access or content. However, by way of example, the user may want to limit the type or size (e.g., in terms of the number of bytes) of the advertisement when bandwidth is limited or shared. Thus, the system may enable the user to specify ad acceptance criteria, which may include size, type (e.g., text, graphics, photographs, video, and/or audio), source, rating, etc., which will be used by the system to determine whether or not to permit an ad to be displayed to the user. This form of advertisement control may also appeal to access providers who often pay significantly more to enable greater bandwidth. By restricting undesirable content from traversing their systems, access providers can reduce their costs and improve user browsing experience without requiring the installation of expensive equipment that throttles bandwidth at the network layer.

A LAACRT registration system may be implemented as a client program or an Internet application that may permit publishers and/or advertisers to register with a registry their entity, URL (or other locator information), and optionally other specific data such as publisher category (or categories), contact information, revenues share percentage, types of content, rating status, and optionally enables these registrants to create accounts to manage their registration profile.

The LAACRT registration system may optionally utilize a database or other data store to store certain characteristics regarding content publishers including, but not limited to, the publisher name, the business entity, the publisher URL, the IP address or IP addresses assigned to or used by the publisher, the type of published content, the publisher's self-determined rating (e.g., an age appropriateness rating, a violence rating, a sexual content rating, an obscene language rating, etc.), a public or industry accepting rating (e.g., an age appropriateness rating, a violence rating, a sexual content rating, an obscene language rating, etc.), fees associated with certain content, and/or other such information to enable the registry to accurately define and validate publishers.

In some embodiments, the LAACRT registration system may be implemented as a database in a central computer (which may comprise multiple geographically distributed systems) that is referenced by the network nodes in determining whether to pass published content to a viewer. This technique enables certain information to be omitted from the individual ad tags. For example, the fee structure for a particular publisher may be standardized, and a given an ad served that is provided by that publisher may be assigned that particular fee structure. Accordingly, the fee structure need not be included in the individual ad tags, but rather may be retrieved from the central computer containing the LAACRT registration system.

In other embodiments, the LAACRT registration system may be implemented as a syndicated database or list, in which the database or list is copied to distributed locations on the network (e.g., the Internet). For example, the distributed locations may include a series of distributed servers or proxies. As noted above, this may permit certain information to be omitted from individual ad tags, such as Type, Fee, etc.

Accordingly, the database of registered ads may be accessed in a number of ways, including by way of example, via an HTML page, as a syndicated reference list, and/or as a central reference list. In any of these approaches, whether a given advertiser has agreed to pay a fee can be determined by querying the database. If the database response to the query with an indication advertiser has not agreed to pay such a fee, the content may be blocked, and different content may be served instead.

In order to prevent or inhibit fraud, spoofing or other method to circumvent validation, the LAACRT registration system may optionally utilize other certificate authorities or listing services, such as the Internet Directory Naming Service (DNS) by way of example, to further validate a publisher. For example, the Internet DNS is a service that resolves and translates URLs, such as Yahoo.com, Google.com, and NYTimes.com, into the physical Internet IP Addresses these URL represent, enabling computers and routers to connect with their respective Internet services. For example, an Internet PING for Yahoo.com may return 209.191.122.70 from DNS Service hosted by AT&T. A PING for Google.com and NYTimes.com returns 74.125.224.180 and 199.239.136.200 respectively. This information may be used by the system to compare and match published content source address with registered addresses to validate publisher integrity.

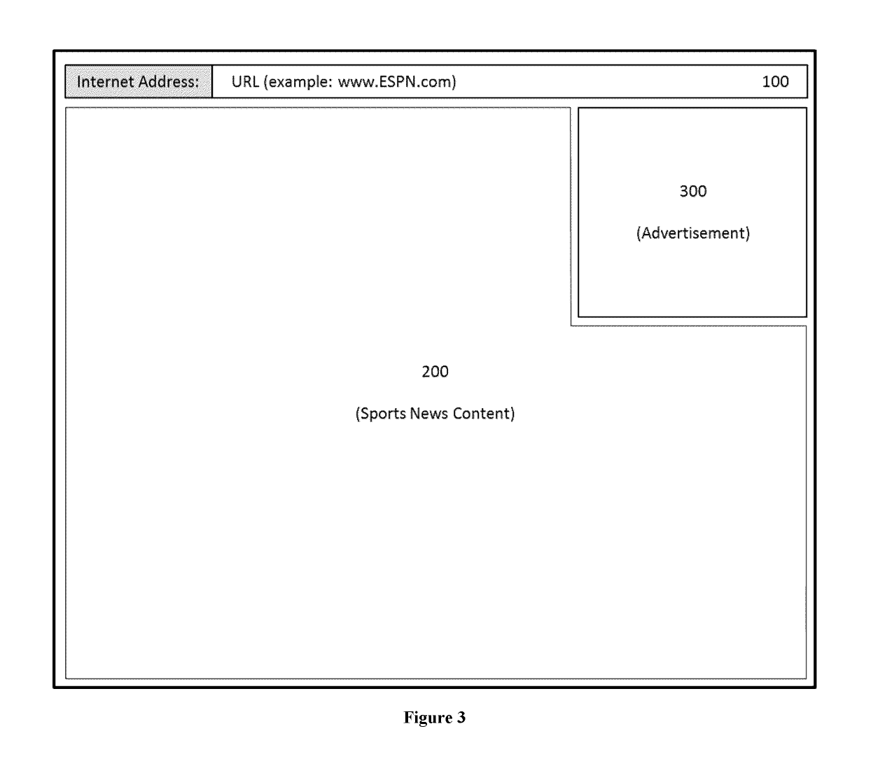

For example, FIG. 3 illustrates further the utilization of the DNS to help verify a publisher's Internet credentials. In this example, a popular sports destination site 100 is providing recent sports news 200, and embedded next to or in-line with the article is an advisement from a large ad network or well-known advertiser 300.

In this example, the sport news site 100 has previously registered with the LAACRT registration system as a publisher, and listed its known IP addresses from which the site 100 publishes. The news article 200 being published is encapsulated with HTML content tags that reference respective registry identifier(s) and other attributes regarding the article 200 content. Similarly, the advertiser 300, providing the advertisement and/or ad tag, also encapsulates their content with HTML tags referencing respective registry identifier(s) and other attributes describing the content being provided by the advertiser (an advertisement).

By way of example, the advertiser may register their entity and IP addresses, which may be used by the system to authenticate the advertiser when placing the advertiser's ads. The advertiser may also specify, via a form hosted by the system or otherwise, a revenue sharing specification (e.g., a general revenue share of 25%) which would be applied to the advertiser's paid ads. Optionally, an ad tag itself might include attributes (e.g., value pairs) identifying the publisher, advertisement, advertisement dimensions, advertisement type (e.g., CPM, CPC, etc.), ad revenue (e.g., ad revenue per impression), ad rating (e.g., G, Youth, PG, PG13, R, Mature, etc.), ad event (e.g., pay per click), ad encoding format (e.g., UTF), etc. The following are example attributes that may be associated with a particular example ad:

Publisher ID=234,

Ad ID=Number to track a particular impression for audit,

Ad Size/Shape

Ad Height=300

Ad Width=250

Ad Type=CPM

Ad Revenue=0.0001/Ad or 0.1/1000 impressions

Ad Rating=G

Ad Event=Pay-Per-Click too

Ad Local=UTF

As noted previously, in some embodiments one or more of these attributes may be omitted from the ad tag itself. The system may store, maintain and provide/output an audit record report indicating the ad detail and the network(s) the ad traversed, and optionally including an identification that the ad was delivered and/or displayed on the user's terminal.

Therefore, in certain embodiments, the ad network may also register with system and may include an ad network identifier in the ad network's data associated with the ad.

Optionally, the foregoing tags and/or other related tags may form the basis of a formal or informal standard, so that publishers may expose their revenue paid via a tag attribute (which may be relatively fast but viewable by end users and competitors) and/or a via reference look-up table where the look up is performed using an identifier, such as an Ad ID, that enables the system to identify the corresponding access rule(s) to be used to query the revenue amount and let the ad pass so that it may be delivered to a viewer terminal or prevent the ad from reaching the viewer terminal and/or from being displayed via the viewer terminal. If the ad is prevented from reaching the viewer terminal, another ad may be selected and substituted by the system (e.g., based on user demographics and/or user interests, or without taking into account user specific information) to take the place of the banned advertisement, and the replacement ad may be displayed with the surrounding content (if any) on the user's terminal.

For the purpose of this example the following scenarios may occur in determining whether to permit an advertisement from an advertiser to be permitted to pass through one or more network provider systems and be displayed on a user terminal:

the advertiser has not previously registered with the registry;

the advertiser has previously registered with the registry and provided all the information to be validated in order to permit the advertiser's ads to be permitted to pass to the user terminal;

the advertiser has previously registered and has not provided all the information to be validated;

the advertiser has previously registered and has provided all the information to be validated but was not allowed to pass because of specific conditions or based at least in part on rules set by the network owner;

the tag represents a previously registered advertiser but failed authentication or appears fraudulent and was not permitted.

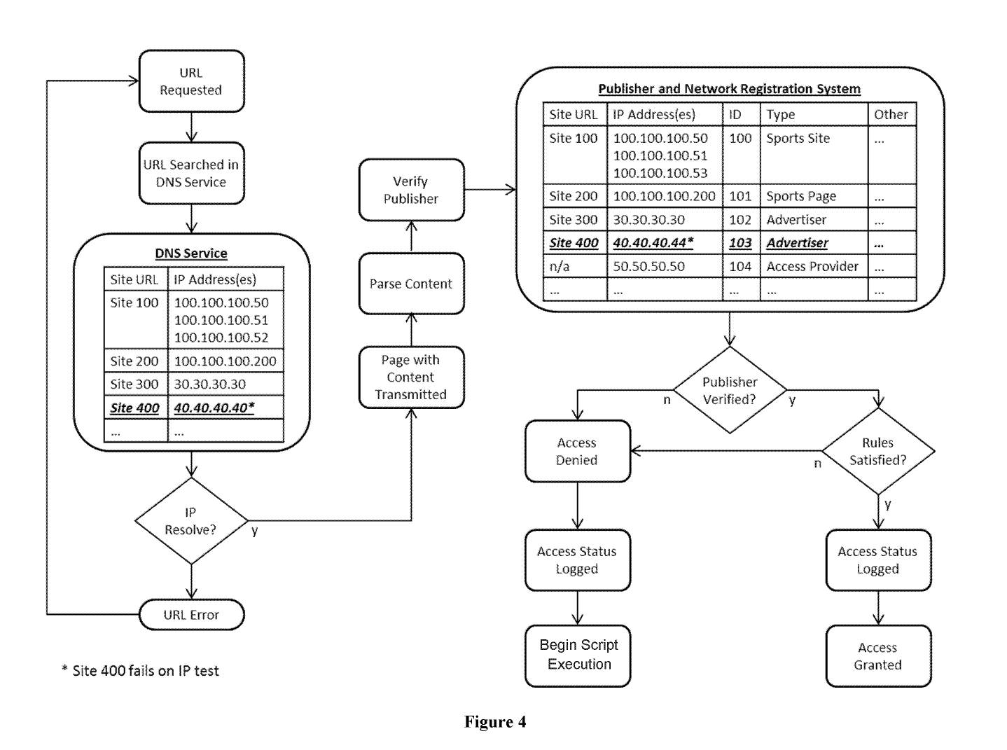

To simplify this example for illustrative purposes it will be assumed that the sport site 100 has previously registered with the LAACRT registration system and satisfies all authentication criteria needed to permit their content to pass, and only consider the Advertiser for this authentication example. FIG. 4 helps illustrate this example.

Given that HTTP and similar Internet protocols use URL references to link content to a source publisher, then in this case the Advertiser's 300 content would have been served either directly from the Site Publisher 100 or as a reference using ad tags or a URL that link to the Advertiser's 300 content or advertisement. Since the source of the content is inherently resolved by the DNS, its origination can be validated using the LAACRT registration system before the content is permitted to pass over the access provider's network.

If the advertiser 300 has previously registered and entered its correct IP address then the values returned by the DNS will match those entered for this specific advertiser 300 thereby enabling the LAACRT system to validate the authenticity and integrity of the publisher. If the advertiser 300 has not previously registered or the data stored in the advertiser's 300 profile does not match DNS values, the LAACRT system may prevent or inhibit the content from passing over the network at issue. For example, the LAACRT system may strip the advertiser's 300 content by removing links, files, or documents from the site 100. Similarly, if the advertiser 300 has registered with the registry, but the advertisement data failed to be validate, a message or error status may be transmitted by the system to the registered advertiser by email, instant message, short message, application, or other technique, and the message or error status may also be logged in the registry database, which may be provided via an advertiser account user interface for that advertiser to review. However, optionally, it is not sufficient for the advertiser 300 to be validated in order to be permitted to pass through the access provider's network. Optionally, there may be several rules or prerequisites each content provider or advertiser must meet before the content is permitted to traverse their networks.

As illustrated, once access is denied, the access status is logged, and then the LAACRT system begins script execution (see, e.g., the example of FIG. 2). Accordingly, once content has been stripped or blocked, the LAACRT system may then replace the stripped or blocked content 300 with a LAACRT Placeholder Tag, as described above. Beginning the script execution may solicit bids for advertisements to replace the Placeholder Tag, as described above with respect to FIG. 2.

The LAACRT registration system may also help Internet access providers protect their customers from potential viruses because it optionally authenticates the source for a given script delivered to a computer. It also may help Internet access providers better manage their bandwidth by optionally implementing content publisher rules that actively select, default to lower bandwidth content options, block content, or substitute preferred content over higher cost content.

The LAACRT registration system may also provide reporting services that enable publishers to view where and when their content was permitted entry and where (e.g., over which private networks, on which terminals) and when their content was not allowed. When their content was not allowed, the database may record and report reasons why the content as not allowed, such as poor ratings, inappropriate content, insufficient entry fee, lost to competitive bid, or other reasons rules or requirements implemented by the Internet access provider.

In many cases there may be several Internet access providers connected together to form a complete path from the publisher to the end user. This series of network connections may represent a content distribution network in which each of the connect segments may be registered in the content authentication registry.

The content authenticate registry service may also enable Internet Access Providers to register their networks and network nodes in this registry to enable the tracking and reporting of when and where content was permitted or denied access to pass through a particular network or portion thereof. This data may include information describing the network and the admission rules.

Another optional feature of this system is its ability to help avoid DNS Poisoning or DNS Redirects. This occurs when a DNS service is compromised or a non-regulated, un-trusted DNS service is placed between the requesting URL and a valid DNS service. An example embodiment of the LAACRT registration system helps ensures the content is being published from a validated source by comparing the resolved IP Address with the registered IP Address. When an invalid DNS is present, the system can intercept DNS requests, but the IP Address for the URL returned will not match the IP Address registered in the publisher and network registration service, causing an error or alert condition to be generated by the system.

In some embodiments described herein, the LAACRT registration system operates as an “allow” list, in which content is blocked from being presented to a user unless the publisher has been registered and the content meets any other criteria present. However, in other embodiments, the LAACRT registration system may be configured to operate as a “block” list, in which content is allowed to pass through to be viewed by a user unless the content has been identified by the system as impermissible. For example, the system may be configured to block all advertisements provided by a particular publisher, such as Double-Click or Value-Click. In either case, when the system prohibits certain content from passing to a user, for example by stripping the content from a web page, LAACRT can solicit bids and optionally display replacement content as described elsewhere herein.

Certain embodiments may be implemented via hardware, software stored on media, or a combination of hardware and software. For example, certain embodiments may include software/program instructions/modules stored on tangible, non-transitory computer-readable medium (e.g., magnetic memory/discs, optical memory/discs, RAM, ROM, FLASH memory, other semiconductor memory, etc.), accessible by one or more computing devices configured to execute the software (e.g., servers or other computing device including one or more processors, wired and/or wireless network interfaces (e.g., cellular, Wi-Fi, Bluetooth, T1, DSL, cable, optical, or other interface(s) which may be coupled to the Internet), content databases, customer account databases, etc.). Data stores (e.g., databases) may be used to store some or all of the information discussed herein in memory.

By way of example, a given computing device may optionally include user interface devices, such as some or all of the following: one or more displays, keyboards, touch screens, speakers, microphones, mice, track balls, touch pads, tilt sensors, accelerometers, biometric sensors (e.g., fingerprint or face recognition sensors for authenticating a user) printers, etc. The computing device may optionally include a media read/write device, such as a CD, DVD, Blu-ray, tape, magnetic disc, semiconductor memory, or other optical, magnetic, and/or solid state media device. A computing device, such as a user terminal, may be in the form of a general purpose computer, a personal computer, a laptop, a tablet computer, a mobile or stationary telephone, an interactive television, a set top box coupled to a display, etc. Certain embodiments may be able to conduct hundreds (or more) of transactions and processes described herein within a second.

While certain embodiments may be illustrated or discussed as having certain example components, additional, fewer, or different components may be used. Process described as being performed by a given system may be performed by a user terminal or other system or systems. Processes described as being performed by a user terminal may be performed by another system. Data described as being accessed from a given source may be stored by and accessed from other sources. Transmissions described herein may be via a wired and/or wireless network or other communications link. Further, with respect to the processes discussed herein, various states may be performed in a different order, not all states are required to be reached, and fewer, additional, or different states may be utilized.

User interfaces described herein are optionally presented (and user instructions may be received) via a user computing device using a browser, other network resource viewer, or otherwise. For example, the user interfaces may be presented (and user optionally instructions received) via an application (sometimes referred to as an “app”) installed on the user's mobile phone, laptop, pad, desktop, television, set top box, phone, or other terminal. Various features described or illustrated as being present in different embodiments or user interfaces may be combined into the same embodiment or user interface. While reference may be made to webpages, other types of electronic documents (including those not based on HTML) may be used. While reference may be made to websites, other network resources may be used.

Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein. Further, embodiments may include several novel features, no single one of which is solely responsible for the embodiment's desirable attributes or which is essential to practicing the systems, devices, methods, and techniques described herein. In addition, various features of different embodiments may be combined to form still further embodiments. For example, aspects found in different user interfaces may be combined to form still further user interface.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

What is claimed is:

1. A method of selecting and displaying digital content at a user terminal, the method comprising:
receiving, at the user terminal, data for a webpage from a remote system, wherein the webpage is to be displayed on the user terminal;
causing, at least in part, an automatic identification of a first advertisement in the webpage data, wherein the first advertisement is configured to be displayed in a first area of the webpage;
replacing said first advertisement with a placeholder;
collecting information comprising:
(a) information related to the webpage;
(b) information related to the user; or
(c) both (a) and (b);
soliciting bids for advertising content to be displayed in the first area corresponding to the placeholder, wherein soliciting the bids comprises providing at least a portion of the collected information;
receiving bids for advertising content to be displayed in the first area;
selecting a winning bid from among the received bids; and
causing, at least in part, advertising content associated with the winning bid to be displayed on the user terminal in the first area corresponding to the placeholder.

2. The method of claim 1, wherein the first advertisement comprises a link to advertisement content.

3. The method of claim 1, wherein said placeholder comprises a container or ad tag.

4. The method of claim 1, wherein information related to the user comprises demographic information.

5. The method of claim 1, wherein soliciting bids comprises soliciting bids from multiple advertising exchanges.

6. A method of selecting and displaying digital content, the method comprising:
receiving, at a network node, data for a first document from a remote system, wherein the first document is to be displayed on a user terminal of a user;
causing, at least in part, an automatic identification of a first advertisement in the first document data;
soliciting bids for replacement content to be displayed on the user terminal in place of the first document;
receiving bids for replacement content;
selecting a winning bid from among the received bids; and
causing, at least in part, replacement content associated with the winning bid to be displayed on the user terminal in place of the first document.

7. The method of claim 6, wherein the network node is the user terminal.

8. The method of claim 6, wherein the first document comprises a web page.

9. The method of claim 6, wherein the first advertisement comprises a link to advertisement content.

10. The method of claim 6, wherein soliciting bids for replacement content comprises:
providing information related to the user,
providing information related to the first document,
or both.

11. The method of claim 6, wherein soliciting bids comprises soliciting bids from multiple advertising exchanges substantially simultaneously.

12. The method of claim 6, wherein selecting a winning bid comprises comparing the received bids and identifying a bid with the highest offered price.

13. The method of claim 6, further comprising storing a record of the winning bid.

14. The method of claim 12, further comprising causing, at least in part, said record to be provided to one or more of bidders of the received bids.

15. A system, comprising:
a processor;
tangible, non-transitory media configured to store a program that when executed by the processor is configured to perform operations, comprising:
receiving, at a network node, data for a first document from a remote system, wherein the first document is to be displayed on a user terminal of a user;
causing, at least in part, an automatic identification of a first advertisement in the first document data;
soliciting bids for replacement content to be displayed on the user terminal in place of the first document;
receiving bids for replacement content;
selecting a winning bid from among the received bids; and
causing, at least in part, replacement content associated with the winning bid to be displayed on the user terminal in place of the first document.

16. The system of claim 15, wherein the network node is the user terminal.

17. The system of claim 15, wherein the first document comprises a web page.

18. The system of claim 15, wherein the first advertisement comprises a link to advertisement content.

19. The system of claim 15, wherein soliciting bids for replacement content comprises:
providing information related to the user,
providing information related to the first document,
or both.

20. The system of claim 15, wherein soliciting bids comprises soliciting bids from multiple advertising exchanges substantially simultaneously.

21. The system of claim 15, wherein selecting a winning bid comprises comparing the received bids and identifying a bid with the highest offered price.

22. The system of claim 15, wherein the operations further comprise storing a record of the winning bid.

23. The system of claim 15, wherein the operations further comprise causing, at least in part, said record to be provided to one or more of bidders of the received bids.
